(19) United States
(12) Patent Application Publication
(10) Pub. No.: US 2013/0199730 A1
(43) Pub. Date: Aug. 8, 2013

(54) Wafer bonding chamber with dissimilar wafer temperatures

(71) Applicants: Chris Gudeman, Lompoc, CA (US); Jeffery F. Summers, Santa Barbara, CA (US); Douglas L. Thompson, Goleta, CA (US)

(72) Inventors: Chris Gudeman, Lompoc, CA (US); Jeffery F. Summers, Santa Barbara, CA (US); Douglas L. Thompson, Goleta, CA (US)

(73) Assignee: Innovative Micro Technology, Goleta, CA (US)

(21) Appl. No.: 13/385,214

(22) Filed: Feb. 8, 2012

(51) Int. Cl. B32B 37/06; B32B 37/08

(52) U.S. Cl. 156/379.6; 156/498

(57) ABSTRACT

A wafer bonding chamber is disclosed, which maintains two wafers to be bonded together at two substantially different temperatures. A lid wafer may be held at a higher temperature than a device wafer, as the device wafer may have delicate structures formed thereon, which cannot withstand higher temperatures. The lid wafer may have an adhesive bonding material formed thereon, which is melted or cured at the higher temperature. The temperature differential may be maintained by applying at least one of a heating mechanism and a cooling mechanism preferentially to one of the wafers to be bonded in the wafer bonding chamber.

### CROSS REFERENCE TO RELATED APPLICATIONS

This application is related to U.S. patent application Ser. No. 13/137,883, filed Sep. 20, 2011, and incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

This invention relates to the sealing of microelectromechanical systems (MEMS) devices in an enclosure and the method of manufacture of the sealed enclosure. In particular, this invention relates to the formation of a hermetic seal at a low temperature between a fabrication wafer supporting a MEMS device, and a lid wafer enclosing the MEMS device.

Microelectromechanical systems (MEMS) are devices often having moveable components which are manufactured using lithographic fabrication processes developed for producing semiconductor electronic devices. Because the manufacturing processes are lithographic, MEMS devices may be batch fabricated in very small sizes. MEMS techniques have been used to manufacture a wide variety of sensors and actuators, such as accelerometers and electrostatic cantilevers.

MEMS techniques may be used to manufacture small detectors and emitters, such as infrared bolometers. These devices may require evacuated cavities to function properly, so that the emitter or detector may be placed in a sealed device cavity during or after fabrication. The sealed cavity may be formed by placing a lid wafer and a device wafer in an evacuated wafer bonding chamber, and bonding the two wafers to form a two-wafer assembly with a hermetic seal to form the evacuated device cavity enclosing the infrared device.

MEMS techniques have also been used to manufacture electrical relays or switches of small size, generally using an electrostatic actuation means to activate the switch. In the MEMS switches, a thin cantilevered beam of silicon is etched into the silicon device layer, and a cavity is created adjacent to the cantilevered beam, typically by etching the thin silicon dioxide layer to allow for the electrostatic deflection of the beam. Electrodes provided above or below the beam may provide the voltage potential which produces the attractive (or repulsive) force to the cantilevered beam, causing it to deflect within the cavity.

Because the MEMS devices often have moveable components such as the electrical relay, or require a vacuum, such as the infrared bolometer, they typically require the enclosure of the device by sealing it with a protective cap or lid wafer, to form a device cavity as mentioned. The lid wafer may be secured to the device wafer by some adhesive means, such as a low outgassing epoxy.

However, the epoxy bond may not be hermetic, such that the gas with which the MEMS device is initially surrounded during fabrication, escapes over time and may be replaced by ambient air, or the vacuum is eventually lost via gas leakage through the seal. Accordingly, it may be preferable to seal the MEMS device in a hermetic, i.e., non-leaking enclosure.

Furthermore, the deposition techniques used to form the thin layers often result in gases incorporated in the layers during deposition. These devices may then be encapsulated in an evacuated cavity for proper functioning. However, the gases incorporated in the films may escape from the layers during the lifetime of the device, raising the pressure in the evacuated cavities. Accordingly, many designs include a “getter” material, namely a reactive, generally metal layer, whose purpose is to absorb these gases, and maintain the vacuum levels within the package. Because of the reactive nature of these materials, they also tend to oxidize at the surface, forming an oxide layer that must be removed in order to activate the getter.

Infrared applications in particular, may require very low pressure environments, such as sub 10-Torr. Achieving such a pressure over the lifetime of the device generally requires such a gettering material to be sealed in the cavity to absorb impurity gases released or leaked into the cavity over time. Thus, in order to maintain the environment around the MEMS device, the seal may need to be hermetic, and a getter may also need to be provided in the device cavity.

Current packaging techniques for vacuum-encapsulated packages require high temperatures, in excess of 400 C, to activate the getters. At this temperature, the oxide layers on the surface of the getter are generally driven into the bulk of the getter material, leaving the surface relatively clean and able to absorb additional impurity gases. These high temperatures are consistent with those required to fuse glass frit, which is often used for vacuum encapsulation, because the melting temperatures simultaneously fire, or activate, the getter. Accordingly, the step of sealing the device in the frit also activates the getter.

However, because the MEMS devices may be made with thin, delicate metal layers, the device may not be able to withstand the high temperatures required to form a hermetic seal or activate the getter. While low temperature bonding materials exist, the device must still be exposed to high temperatures in order to activate the getter. For this reason, vacuum applications requiring a low temperature bonding mechanism have been hampered in development.

### SUMMARY

The systems and methods described here form a hermetic seal between a device wafer and a cap or lid wafer using a hermetic bonding material, to form a two-wafer assembly. The seal construction may include a bonding material which is applied to at least one of the wafers of the two-wafer assembly. This wafer may then be heated preferentially within the wafer bonding chamber to activate the bonding material, whereas the device wafer remains cool. Thus, the wafers inside the bonding chamber may be held at two substantially different temperatures. These substantially different temperatures may be achieved by one or more: heating the upper lid wafer; cooling the lower device wafer; providing a heat shield between the upper and lower wafers; illuminating the upper wafer with a radiation source such as a laser; cooling the lower wafer by applying an inert gas or refrigerated liquid to the backside of the wafer chuck; and heating only specific structures in the device by providing an magnetically permeable layer under the structure, and heating that layer by inductive coupling to a coil driven by an RF signal. These are examples of different embodiments, and the list is not meant to be exhaustive, but instead to provide examples of the inventive concept.

One example of a useful hermetic seal is a metal alloy bond, such as an indium layer deposited over a gold layer. The gold and indium layers are then heated to a temperature beyond the melting point of the indium (156 C.°). The heat required to produce this temperature may be applied only to one of the wafers, that is, the lid wafer may be heated to this temperature, whereas the lower device wafer remains cool. In this way, the delicate features of the device wafer are protected from the higher temperatures.

The AuInₓ alloy is an example of a class of bonding mechanisms known generally as solid/liquid interdiffusion bonds (SLID). These bonds generally make use of a lower melting temperature first component which forms a bond with a higher temperature solid second component. The bond is often a metallic alloy of a low melting temperature metal such as indium and the higher temperature metal such as gold. The requirement to heat the components is limited because of the low melting temperature of the first component of the SLID bond. The metal layer for the SLID bond may also be deposited over a rigid raised feature formed on the surface of one substrate, which in turn forms a raised region in the metal layer. This raised region then penetrates the opposing layer of the other metal deposited on the other substrate, thereby ensuring a region relatively rich in composition of metal of the raised feature.

The wafer bonding chamber may include a plurality of fixtures, each supporting one wafer on a frontside of the fixture, and at least one of a heating mechanism and a cooling mechanism, configured so as to maintain one of the wafers in one of the fixtures at a substantially different temperature than another wafer in another of the plurality of fixtures. Several embodiments of these ideas are described below, as examples of the inventive concept.

### BRIEF DESCRIPTION OF THE DRAWINGS

Various exemplary details are described with reference to the following figures, wherein:

FIG. 1 is a schematic diagram of a generic wafer bonding system, having two wafer chucks that hold two wafers at substantially dissimilar temperatures;

FIG. 2 is a schematic diagram of a wafer bonding system, having two wafer chucks that hold two wafers at substantially dissimilar temperatures, by holding the upper wafer at a substantially higher temperature than the lower wafer, by applying a heat source to the upper wafer;

FIG. 3 is a schematic diagram of a wafer bonding system, having two wafer chucks that hold two wafers at substantially dissimilar temperatures, by holding the lower wafer at a substantially lower temperature than the upper wafer, by applying a cooling mechanism to the lower wafer;

FIG. 4 is a schematic diagram of a wafer bonding system, having two wafer chucks that hold two wafers at substantially dissimilar temperatures, by holding the lower wafer at a substantially lower temperature than the upper wafer, by providing a heat shield between the upper and the lower wafer;

FIG. 5 is a schematic diagram of a wafer bonding system, having two wafer chucks that hold two wafers at substantially dissimilar temperatures, by holding the upper wafer at a substantially higher temperature than the lower wafer, by applying a heat source to the upper wafer, wherein the heat source is a radiative source such as a laser;

FIG. 6 is a schematic diagram of a wafer bonding system, having two wafer chucks that hold two wafers at substantially dissimilar temperatures, by holding the lower wafer at a substantially lower temperature than the upper wafer, by applying a cooling mechanism to the lower wafer, wherein the cooling source is a stream of inert gas directed to the backside of the wafer chuck;

FIG. 7 is a schematic diagram of a wafer bonding system, having two wafer chucks that hold two wafers at substantially dissimilar temperatures, by holding the upper wafer at a substantially higher temperature than the lower wafer, by applying an RF signal to a coil surrounding the upper wafer and heating the upper wafer by inductive coupling;

FIG. 8 is a schematic diagram of a wafer bonding system, having two wafer chucks that hold two wafers at substantially dissimilar temperatures, by holding the upper wafer at a substantially higher temperature than the lower wafer, by applying an RF signal to a coil embedded in the upper chuck which heats the upper wafer by inductive coupling; and

FIG. 9 is a schematic diagram of a cross section of a two-wafer assembly, wherein at least one wafer includes magnetically permeable material underneath the bonodline, which heats the bondline preferentially by magnetic coupling between the magnetically permeable material and the RF coil.

### DETAILED DESCRIPTION

As mentioned previously, many vacuum encapsulated devices have used a glass frit adhesive to bond two substrates together, wherein the substrates define an evacuated device cavity in the wafer assembly that encloses a microdevice. The glass frit provides a hermetic seal around the device cavity, maintaining the vacuum therein. Glass frit requires high melting or bonding temperatures, which may destroy the delicate structures of the microdevice. However, these high temperatures are also needed to activate the getter enclosed in the device cavity. Therefore, if using a lower temperature bonding method is used, some other means must be devised for activating the getter which requires the higher temperatures.

Many devices and especially so-called microelectromechanical systems (MEMS) devices, have delicate structures which cannot withstand these 400+ degree centigrade temperatures. For these devices, a lower temperature bond may be used, for example, a metal alloy bond such as that described in U.S. patent application Ser. No. 11/211,622, filed Aug. 26, 2005 and U.S. patent application Ser. No. 11/304,601, now U.S. Pat. No. 7,569,926. Each of these documents is incorporated by reference in their entireties. For such applications, the getter must be fired some other way than raising the temperature of the wafer assembly to 400+ degrees centigrade. Furthermore, the getter must be activated within a vacuum cavity, for example within the wafer bonding chamber, and that vacuum maintained in order to avoid the reformation of the passivation layer over the getter surface. This may be done by, for example, heating the lid and device wafers within an evacuated bonding chamber, and then bonding the lid wafer to the device wafer in the bonding chamber. However, the bonding material is generally already placed on the lid wafer before insertion in the bonding chamber, thus requiring a bonding technology to withstand the high temperatures required to activate the getter. If a low temperature metal alloy bonding material is used on the lid wafer, these metal films may be melted, damaged or degraded by the heat.

Accordingly, to date, there has been no way of using a low temperature bond with a device requiring a getter, which has greatly inhibited the development of such devices. There are, indeed, many such devices such as infrared imaging devices or bolometers, which because of their need for an evacuated operating environment, require getters, but their delicate structures cannot withstand high temperatures, and thus they also require both a low temperature bond and getter activation.

Accordingly, the systems and methods described herein may be particularly applicable to the manufacture of microdevices, wherein the manufacturing process makes use of a low temperature bonding methodology, such as a metal alloy SLID bond. The microdevices may be, for example, MEMS devices formed on a semiconductor substrate. Alternatively, they may be integrated circuit devices formed on a semiconductor substrate.

The systems and methods disclosed here may apply a heating or cooling source locally and specifically, using the techniques described herein. The system and method are consistent with bonds that may be formed at low temperature, for example using metal alloy bonds as described in the '926 patent. These materials form a hermetic seal at temperatures less than about 250 degrees centigrade. Depending on the application, the heat applied may be sufficient for melting the adhesive material on the lid wafer, as well as activating the getter material on the lid wafer, while the device wafer is maintained at a substantially lower temperature. Accordingly, the devices supported on the device wafer are not exposed to these higher temperatures.

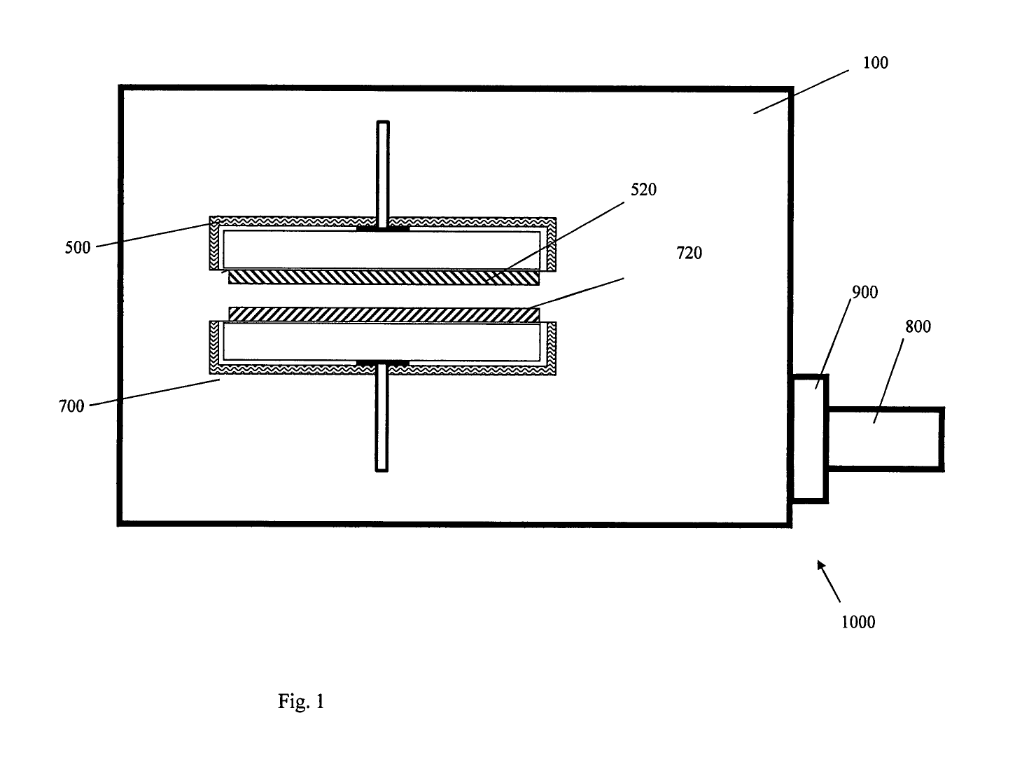

FIG. 1 is a schematic diagram of a generic system 1000 which is capable of bonding two wafers with an adhesive, while avoiding exposing one of the wafers to the heat needed for the bonding or activation. The system includes a bonding chamber 100, which is a single sealed chamber that houses two wafer chucks, a lid wafer chuck 500 and a device wafer chuck 700. A lid wafer 520 may be held in the lid wafer chuck 500 by vacuum or clamping. Similarly, the device wafer chuck 700 may hold a device wafer 720 by vacuum or clamping. These wafer chucks 500 and 700 are used to hold the wafers firmly in place, and may be referred to more generically hereafter as “fixtures”. A vacuum pump 800 and valve 900 are attached to the wafer bonding chamber 100 to maintain vacuum in the chamber.

A unique feature about system 1000 is that the two wafers, lid wafer 520 and device wafer 720, are held at two substantially different temperatures. For example, lid wafer 520 may be approximately 100 F, or more, warmer or cooler than device wafer 720. In one embodiment, device wafer 720 is heated to about 180 F, in order to melt the indium layer of the Au/In bond as described in the '622 application. The lid wafer 520 is brought into contact with the device wafer 720, forming a hermetic AuIn₂ alloy bond. The alloy has a much higher melting temperature, so that the material freezes upon formation, bonding the lid wafer 520 to the device wafer 720 with a hermetic seal. During this process, the device wafer stays cool relatively cool, under 200 F, so that the delicate structures on the device wafer 720 are not damaged or destroyed by the heat. As this entire process takes place within a sealed wafer bonding chamber, some additional and unique features may be added to the bonding chamber to accomplish this task.

A getter material which may be disposed on the lid wafer, may be heated to a higher temperature in order to activate the getter. For example, the lid wafer may support both the getter material and the high melting temperature component of the SLID bond, such as gold (Au). Thus in this case, the two wafers are once again held at substantially different temperatures.

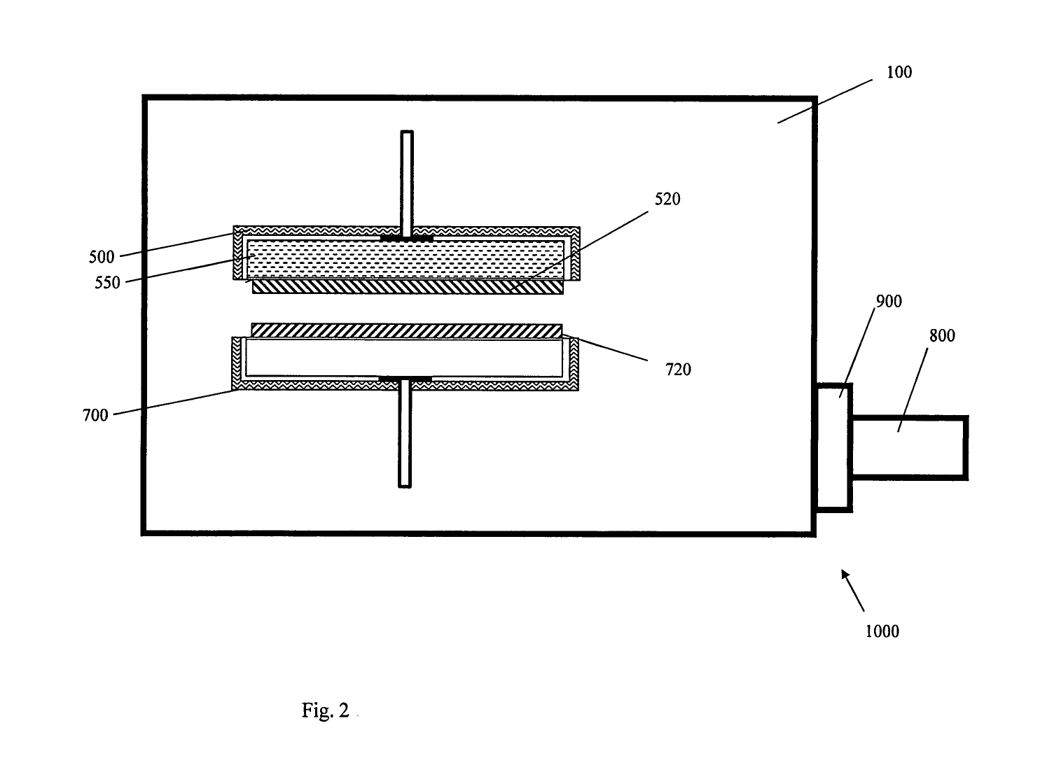

FIG. 2 illustrates on of the embodiments of the concept illustrated in FIG. 1. In FIG. 2, the upper wafer chuck or fixture 500 is equipped with a heating element 550, whereas the lower wafer chuck or fixture 700 is not. Heating element 550 may be a resistive heater, for example, embedded in the upper fixture 500 as shown, and coupled to a power supply (not shown). Alternatively, a quartz heater element may be used with a glass or sapphire fixture which is transparent to the radiation. Although FIG. 2 shows the heating mechanism in direct contact (embedded in) with the upper wafer chuck 500, this is not necessarily the case. Described below are other embodiments wherein the heating mechanism is not directly coupled to the chuck or fixture 500. Alternatively, the heating element 550 may be embedded in, wrapped around or otherwise disposed on wafer chuck or fixture 500, in order to deliver heat to the wafer chuck or fixture 500.

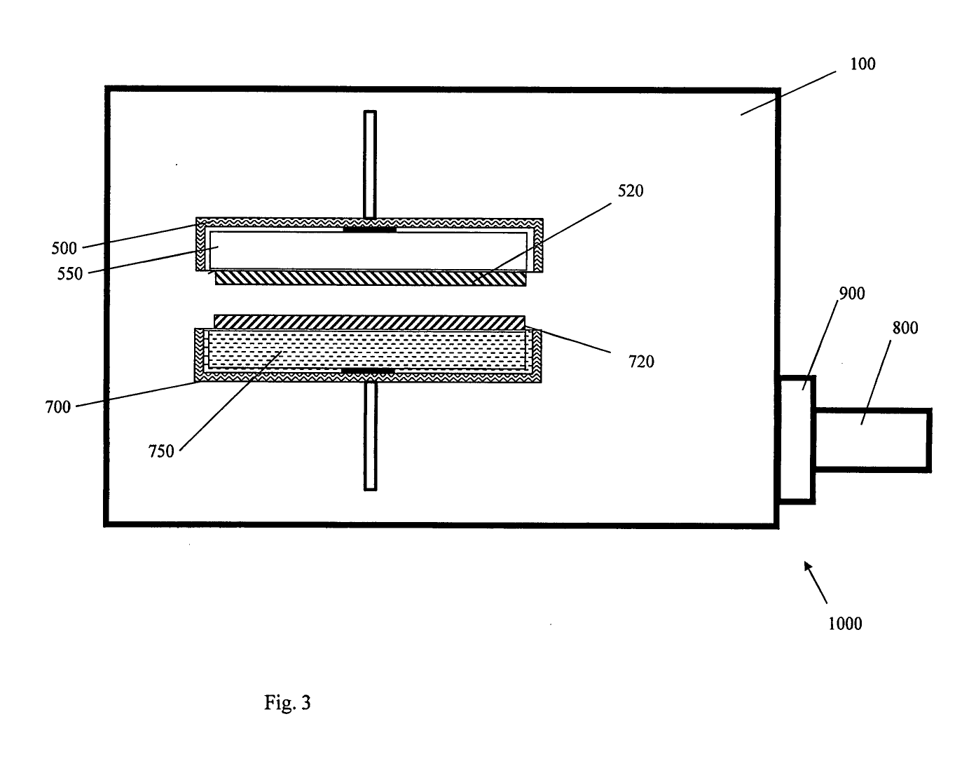

FIG. 3 illustrates another embodiment of the concept shown in FIG. 1. In FIG. 3, a cooling mechanism 750 is provided to the lower wafer chuck 700. This cooling mechanism 750 may be, for example, copper coils through which a refrigerant is pumped. The cool fluid cools the coils which cool the wafer chuck 700. The lid wafer chuck 500 may also have a heating mechanism 550, in addition to the cooling mechanism 750 on device wafer chuck 700, but this is not necessarily the case. At any rate, the device wafer 720 is held at a substantially different temperature than the lid wafer 520. As with the heating mechanism of FIG. 2, the cooling mechanism 750 may be in direct contact (embedded in) with the lower wafer chuck 700, but this is not necessarily the case. Described below are other embodiments wherein the cooling mechanism 750 is not directly coupled to the wafer chuck 700. Alternatively, the cooling element 750 may be embedded in, wrapped around or otherwise disposed upon wafer chuck or fixture 700, in order to cool the wafer chuck or fixture 700.

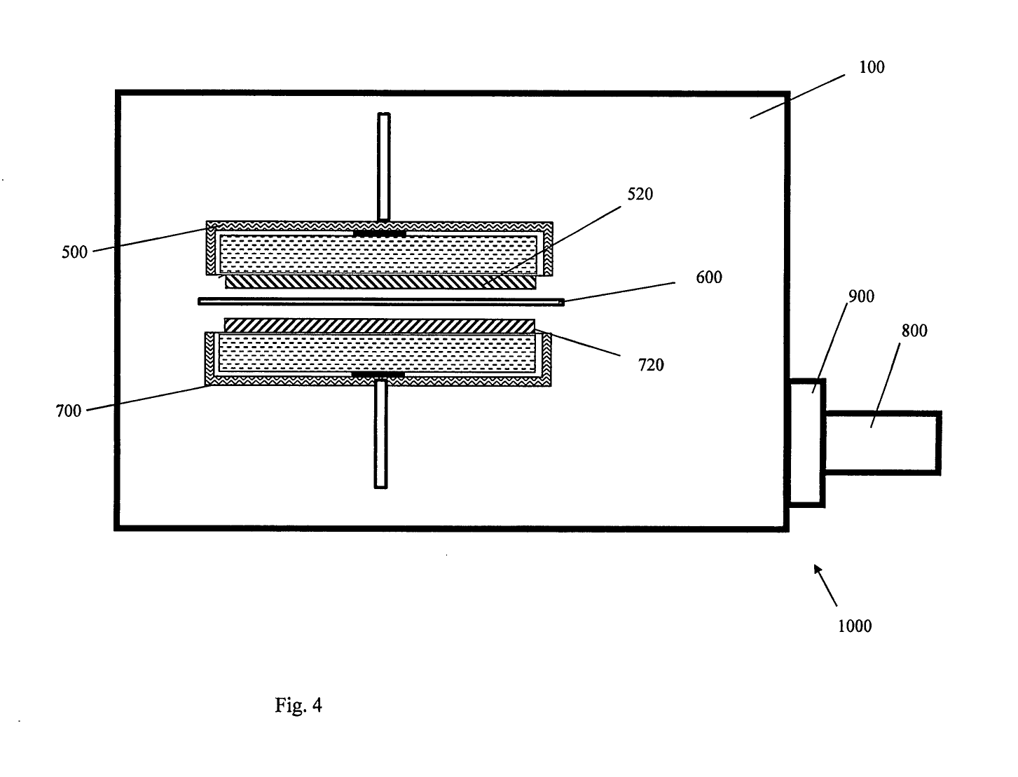

FIG. 4 is a further embodiment of the system 1000. In this embodiment, a heat shield is provided between the upper wafer 520 and the lower wafer 720. This heat shield 600 may inhibit the transfer of energy from the lid wafer 520 to the device wafer 720, and so assist in maintaining the substantial temperature differential between them. This heat shield 600 may be as thin as practically possible, in order to minimize the spacing between the lid wafer 520 and the device wafer 720. Precise alignment of the lid wafer 520 to the device wafer 720 may be required to form the device cavity around the individual devices, and this alignment is easier to accomplish if the distances are not too great. The heat shield 600 may be made of asbestos, ceramic, or other substance which can be made thin and rigid, and is a good thermal insulator.

Because there is a necessary gap between the lid wafer 520 and the device wafer 720 in this embodiment, care may be required in aligning the wafers properly before bonding. Self-aligning methods may be used, such as ball-in-socket techniques known to those of ordinary skill in the art.

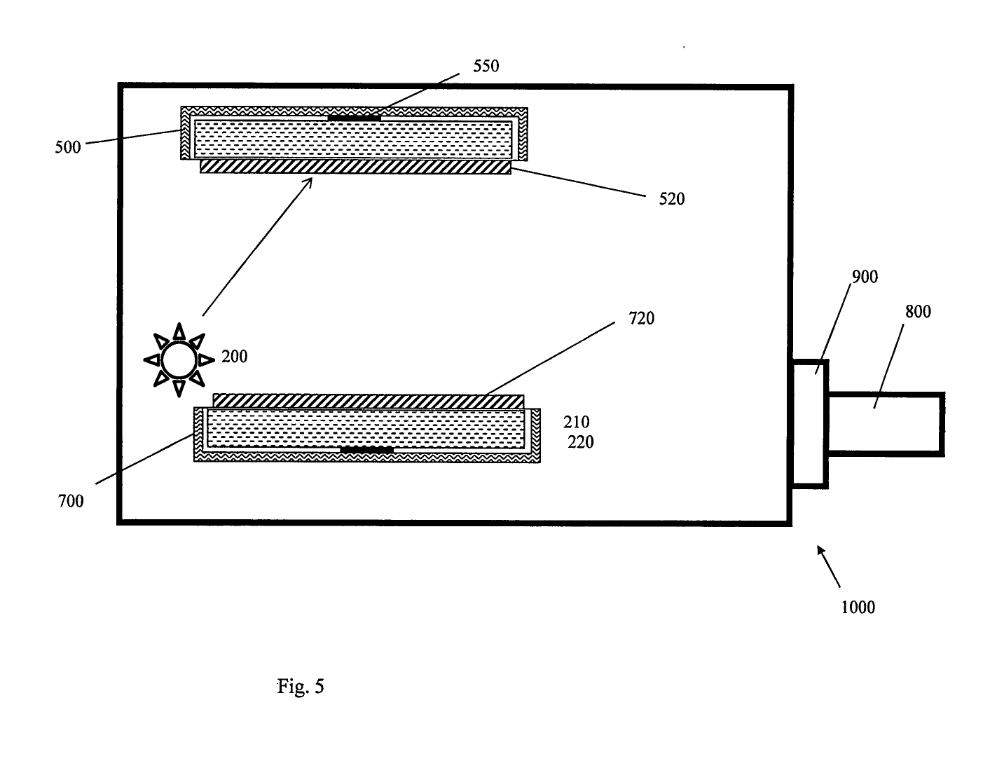

FIG. 5 is a schematic illustration of another embodiment of the wafer bonding system 1000. In this embodiment, a heat source 200 is located within the wafer bonding chamber 100, but not in direct contact with the lid wafer 520 or lid wafer chuck 500. The heat source may be, for example, a directed, radiative source such as a laser which illuminates the surface of the lid wafer 520, heating that surface. The laser may be an infrared laser, such as a Nd:YAG laser emitting at 1.06 um. Alternatively, the source may be an incandescent source whose radiation is shaped with an aperture or slot on the source, allowing radiation to escape only in the direction of the lid wafer 520 surface.

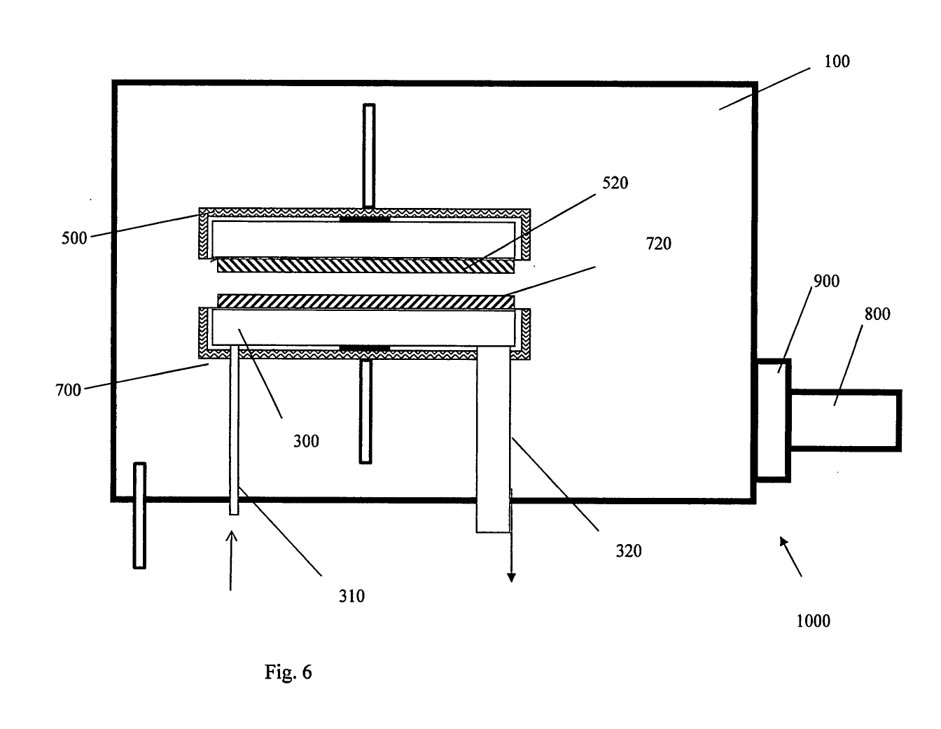

FIG. 6 is a schematic illustration of another embodiment of the wafer bonding system 1000. In this embodiment, a cooling source 300 is located within the wafer bonding chamber 100, and directed at the device wafer 720 but not in direct contact with the device wafer 720 or device wafer chuck 500. The cooling source may be a stream of inert gas, such as helium or neon, which is directed against the backside of the device wafer chuck. The gas stream may be emitted from a inlet jet against the wafer backside, or may be enclosed in a chamber 300 disposed on the backside of the wafer as shown in FIG. 6. An inert gas may be introduced through an inlet channel 310 of ¼″ diameter, at a flow rate of about 20 cfm, for example, and into the chamber 300. The gas enters the chamber through inlet channel 310, flows across the backside of the wafer, and may exit through a wider channel 320. The wider channel 320 may have a diameter of about ½″, for example. In this example, the inert gas used is helium, however other non-reactive gases may be used, such as argon, neon, carbon dioxide or nitrogen, which are consistent with the requirements of the application. Having a substantial heat capacity, the stream of gas carries heat from the device wafer, maintaining it at a temperature at least about 100 F below that of the lid wafer 520.

Alternatively, the inert gas, helium for example, may be introduced directly into the wafer bonding chamber 1000 through a vent, where it circulates around both the lid wafer fixture 500 and the device wafer fixture 700. In this way, inert gas flowing over the device wafer 720 surface may remove heat from that surface, keeping the structures on the device wafer 720 cool relative to the lid wafer 520.

The systems and methods presented here which maintain the lid wafer at a substantially different temperature than the device wafer, may also be implemented using an inductive coupling approach. This approach is described with respect to heating a getter material to activate the getter material, in co-owned U.S. patent application Ser. No. 13/137,883, filed Sep. 20, 2011, and incorporated by reference in its entirety.

In the systems and methods described in the incorporated '883 application, an inductive heating approach is used to heat a getter material preferentially in order to activate the getter material. This application extends the idea to the heating of an adhesive bonding material disposed on the lid wafer, while keeping the device wafer relatively cool. The process may also include the heating of the getter material, as set forth in the '883 patent application.

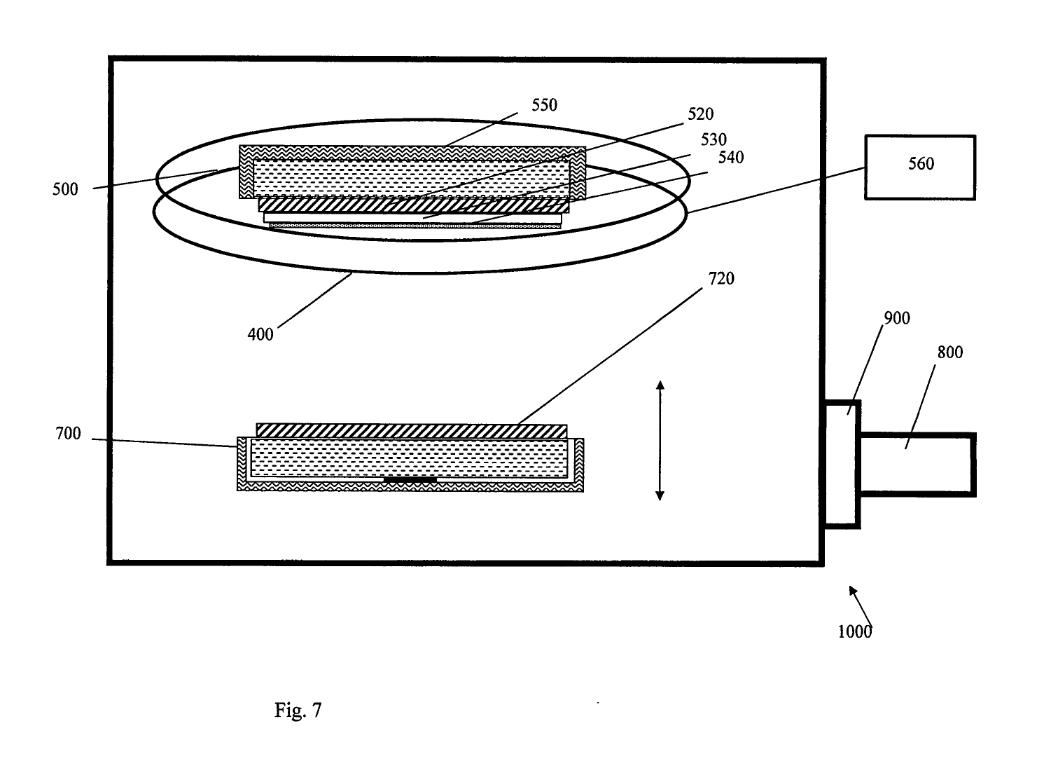

The concept is illustrated in FIG. 7. A supporting substrate 520 is used to support the layers 530 and 540. Substrate 520 may be silicon, glass, ceramic, or any other convenient material that is consistent with lithographic processing. A magnetically permeable material 530 may then be formed or otherwise deposited over the substrate 520. The magnetically permeable material 530 may be, for example, iron (Fe), nickel (Ni), cobalt (Co), neodymium (Nd) and manganese (Mn), or their compounds, such as nickel-iron permalloy (80% Ni, 20% Fe). This layer 530 may be deposited by, for example, sputter deposition to a thickness of several microns. The preferred thickness will depend on the details of the application, such as the amount of heat required to fire the getter or bonding material, its thickness and extent, and the rate of heat loss to surrounding areas and structures. In one embodiment, the magnetic layer is preferably about 3 um thick, but may be anywhere from about 0.5 to about 20 um thick, and may depend on the size of the device cavity. Preferably, this material 530 may have a permeability of between about 1 T to 20 T. While for simplicity the magnetic layer 530 is depicted as a uniform sheet, it should be understood that the magnetic layer 530 may be patterned so that it covers only certain portions of the substrate 520.

A bonding adhesive 540 is deposited over the magnetically permeable material 530. The magnetic and bonding materials may be either be suspended over an empty cavity or deposited over an insulating layer (not shown), in order to promote a local rise in temperature in the vicinity of the magnetically permeable layer 530. These options are described in greater detail below. Then, using a method similar to that described in the '883 patent application, the permeable layer 530 and the bonding adhesive 540 are heated by inductive coupling to an RF coil 400.

A power supply 560 is used to generate an RF signal which is applied to a coil 400 as shown in FIG. 7. The signal generates a changing magnetic field along the axis of the coil, as is well known from fundamental electromagnetism. This changing field then couples into the magnetically permeable material 530, driving eddy currents in the magnetically permeable material 530. These eddy currents may then heat the material 530 through simple Joule heating. The magnitude and frequency of the RF signal needed to heat the bonding layer to 200 C-450 C may be about 200 W and 40 kHz. It should be understood that these values are exemplary only, and the values used in a particular application may depend on the details of that application. Values in the range 1 W-500 W and 1 kHz-100 kHz may be appropriate, or any other values sufficient to heat the bonding material sufficiently to melt or cure it are anticipated. The power required simply to heat the bonding material 540 may be substantially lower than that required to activate the getter as described in the '883 patent application.

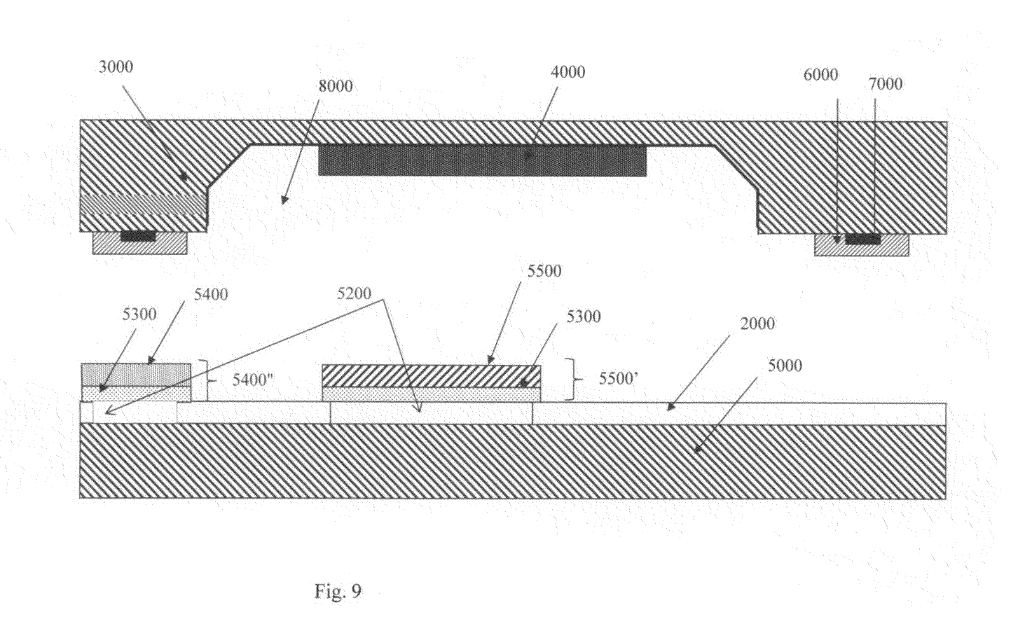

Because the bonding adhesive 540 is deposited over and is in direct contact with the magnetically permeable material 530 over much of its surface, the heat would flow by conduction specifically into the bonding material, heating it preferentially to the rest of the wafer and device structure, which would remain at a relatively low temperature. To increase the efficiency of this heat transfer, the magnetic material may be suspended over a cavity or void formed beneath it, reducing the heat leakage into the substrate thereby. This is described in greater detail below with respect to FIG. 9.

While the system illustrated in FIG. 7 makes use of an inductively coupled, magnetically permeable layer disposed on a substrate, it should be understood that any conductive material will generate eddy currents and could be used to produce the heat. However, this effect can be greatly amplified by using a permeable magnetic material, which effectively amplifies the magnetic flux. In fact, the power dissipated by the eddy currents is proportional to the square of the flux density within the material, thus having the material be magnetically permeable greatly improves the efficiency of this approach. Furthermore, because metal materials will all respond similarly, using a permeable material allows heating of that material preferentially, leaving other conductive structures relatively unaffected. The technique may be applied to encapasulated, singulated, individual devices, or it may be applied to the entire wafer before or after bonding.

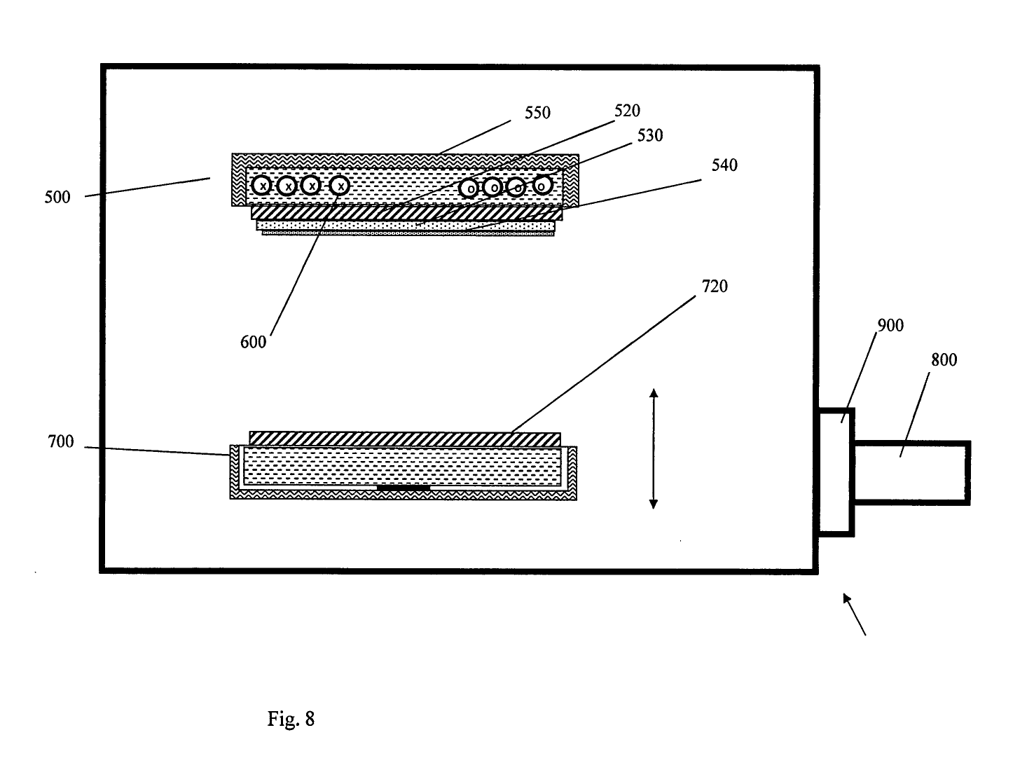

FIG. 8 is a cross sectional view of another embodiment of this concept. In FIG. 8, the RF coils 600 are embedded in the wafer fixture 500 rather than wrapped around it as in FIG. 7. This embodiment has the advantage of maintaining close proximity between the RF coil and the permeable material 530. However, the concept is similar, wherein an RF signal in the coil 600 drives eddy currents in the permeable material 530. This heats the permeable material 530, which is disposed adjacent to a bonding material 540. This heat melts the bonding material 540, such as the low temperature component of the SLID bond described above. It may also heat a getter structure, as described and illustrated below.

The coil 400 or 600 may also be wrapped around a core of permeable magnetic material which will also dramatically increase the magnetic flux produced. This core may be, but need not necessarily be, the same material as magnetically permeable material 5300. A core permeability of between about 10 and 20 T may be suitable. This core may be a composition including iron (Fe), nickel (Ni), cobalt (Co), neodymium (Nd), manganese (Mn) or their alloys. The coil may be brought into proximity to the magnetic layer, but need not be in contact or coupled to the wafer either mechanically or electrically. The coil may be conveniently brought to a distance of about 5 cm to the magnetic layer, or even closer. Alternatively, the coil 600 may be embedded in the wafer fixture which may include permeable material, as was illustrated in FIG. 8. Upon energizing the coil, the temperatures in the magnetic layer may rise rapidly, activating the adjacent bonding material and/or getter material within minutes or even seconds.

FIG. 9 shows an individual microfabricated device 4000 in greater detail, which will be enclosed in a device cavity 8000 along with a getter material 5500 using this method. As in FIGS. 7 and 8, a supporting substrate 5000 is used to support the structure. An insulating material 2000 may be deposited or formed over the substrate 5000. The insulating material may serve as electrical isolation between the conductive magnetically permeable material and the possibly conductive substrate 5000. The insulating material 2000 may be, for example, an oxide such as a layer of silicon dioxide grown or deposited over the surface of a silicon substrate 5000.

As with the embodiment illustrated in FIGS. 7 and 8, the magnetic material 5300 may be formed or otherwise deposited over the insulator 2000. As before, the magnetic material 5300 may be, for example, iron (Fe), nickel (Ni), cobalt (Co), neodymium (Nd) and manganese (Mn), or their compounds, such as nickel-iron permalloy (80% Ni, 20% Fe). This layer may be deposited by, for example, sputter deposition to a thickness of several microns. The preferred thickness will depend on the details of the application, such as the amount of heat required to fire the getter or melt the adhesive, its thickness and extent, and the rate of heat loss to surrounding areas and structures. In one embodiment, the magnetic layer is preferably about 3 um thick, but may be anywhere from 0.5 to 20 um thick, and may depend on the size of the device cavity. Preferably, this material 5300 may have a permeability of between about 1 T to 20 T.

As shown in FIG. 9, a cavity 5200 may be formed under the magnetic layer 5300, by etching away the insulating layer 2000 in this region. The cavity 5200 may be devoid of solid material under a substantial portion of a surface of the magnetically permeable layer 5300. This “substantial portion” may be, for example, 75% or more of the surface of the magnetically permeable layer. This cavity may be evacuated during wafer bonding and subsequent getter activation. Using the system illustrated in FIG. 9, the heat thus produced in the magnetic layer may be isolated from the underlying substrate by the void or cavity, thus minimizing the flow of heat into this heat sink and restricting it largely to the magnetic layer 5300. Thus, the presence of the cavity 5200 beneath the magnetic layer may provide thermal isolation to the magnetic layer, such that the heat generated in the magnetic layer 5300 is available for melting the bonding adhesive 5400 and/or firing the getter layer 5500, rather than being drawn into the thermal sink of the substrate 5000. The cavity 5200 may be formed by wet etching, for example, by applying an etchant such as potassium hydroxide (KOH) to the insulation layer 5200 and etching the cavity in the insulation layer 2000. Methods for forming this cavity are described in greater detail in the incorporated '883 patent application.

A bonding material 5400 and optionally a getter material 5500 may then be deposited over the magnetic material 5300. The bonding material 5400 may be one component of a solid-liquid interdiffusion bond (SLID) bond, such as indium in a gold/indium SLID bond as described in the incorporated '926 patent. The metal layer 5400 may be, for example, 2 microns thick and deposited by sputter deposition over the permeable layer 5300. The other, higher melting temperature component of the SLID bond, for example, gold, may be formed in a layer 6000 on the other wafer.

The getter material 5500 is typically a reactive metal or metal alloy, such as, for example, an alloy of zirconium (Zr), vanadium (V), and iron (Fe) as that described in U.S. patent application Ser. No. 11/819,338, incorporated by reference in its entirety. The getter material 5500 may be deposited over the entire surface of the wafer, or it may be localized to certain areas by patterning. This patterning step may pattern the underlying magnetic layer at the same time. The getter material may be 0.2-3 microns thick and extend over about a 3-4 micron area.

As described previously, the bonding material 5400 and the getter material 5500 may be melted, cured, fired, or otherwise activated, by heating the bonding material 5400 and the getter material 5500 to a temperature at which the layer melts or its passivation layer is driven off. Typically, an indium layer will melt at about 200 F, but the getter material may require higher temperatures, in the range of at least three hundred degrees Centigrade. For the zirconium/vanadium alloy mentioned above, this temperature may be about 450 C. Using the method described here, this temperature may be achieved in the getter material 5500 and the indium layer 5400, while the rest of the structure and the device wafer remains relatively cool.

As with the embodiment illustrated in FIGS. 7 and 8, a power supply may be used to generate an RF signal which is applied to a coil in the vicinity of substrate 5000. The signal generates a changing magnetic field along its axis, which then couples into the magnetically permeable material 5300, driving eddy currents in the magnetically permeable material 5300. These eddy currents may then heat the material through simple Joule heating. As before, the magnitude and frequency of the RF signal needed to heat the getter to 450 C may be about 200 W and 40 kHz. It should be understood that these values are exemplary only, and the values used in a particular application may depend on the details of that application. Values in the range 1 W-100 W and 1 kHz-100 kHz may be appropriate, or any other values sufficient to heat the getter enough to activate its surface are anticipated. The power required simply to heat the bonding material 5400 may be substantially lower.

Upon heating the bonding material 5400 to a sufficient temperature, the lid wafer 5000 may be brought into contact with the device wafer 3000. The bonding adhesive, for example indium 5400, may be pressed against the other component 6000, until the bond is formed. This bond may form a hermetic alloy seal around the device cavity 8000, so that the microfabricated device 4000 is enclosed in a controlled, or vacuum environment.

Using the inductive heating method disclosed herein, it may also be possible to fabricate the device in the device cavity with a two-step process. The first step is the bonding process, whereby the low temperature bonding material is heated to the melting point of the low melting temperature component, at which point the SLID alloy is formed, making a hermetic seal around the cavity. This alloy has a much higher melting temperature, so that the getter, now enclosed in the cavity, may be reheated to a higher temperature, in order to activate its surface. As before, this heat is largely confined to the getter material, so that the rest of the structures within the device cavity remain substantially cooler. This process allows the low temperature component to be protected from the higher activation temperatures, by incorporating it first into the alloy bond.

Since the device 4000 and getter 5500 are already enclosed in the evacuated device cavity, the getter may begin to functioning immediately, and no further processing is needed. The devices can then be singulated from the wafer if they have not yet been.

The device wafer 3000 or the lid wafer 5000 may have the low temperature bonding material 5400 formed substantially in a perimeter around the microdevice 4000. This bonding material 5400 may be combined with a raised feature 7000 as is described more fully in U.S. Pat. No. 7,569,926 and U.S. Pat. No. 7,960,208, incorporated by reference in their entireties, and assigned to the same assignee as the instant application. This low temperature bonding material may be referred to as a SLID bond described previously, a combination of a low melting temperature such as elemental indium (In) and a high melting temperature material such as elemental gold (Au). The raised feature 7000 may be deposited first on the device wafer, followed by conformal deposition of a gold layer, the raised feature produces a corresponding raised feature in the deposited gold layer. When assembling the wafers, the gold protrusion penetrates into the molten layer of the lower melting point metal, here the indium metal 5400, to produce a region which is rich in concentration of the gold. Adjacent to this region will be regions which are indium-rich/gold poor. Between these two regions will occur a region having nearly the exact desired relative concentration of the metals to form the preferred stoichiometry of the alloy.

Accordingly, the raised feature 7000 and other component of the bonding material 6000 may be placed on the device wafer 3000. The lid wafer 3000 and the device wafer 5000 may then be bonded together as described above. After bonding the lid wafer 5000 to the device wafer 3000 in the evacuated bonding chamber 100 described above, the wafer assembly may be removed from the bonding chamber. The getter material 5500, now encapsulated in the device cavity 8000 with the microdevice 4000, may be activated as described above and in the '883 patent application. The getter may be fired using this inductive procedure either before or after bonding the lid wafer to the device wafer. The process may be conducted on either individual devices after singulation, or on the entire wafer before singulation.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Furthermore, details related to the specific methods are intended to be illustrative only, and the invention is not limited to such embodiments. It should be understood that the techniques disclosed herein may be applied to any microdevice, including integrated circuits, which may require a vacuum cavity with a getter enclosed therein, for proper functioning. The techniques may also be combined with other wafer bonding technologies, such as fusion bonding rather than metal alloy or glass frit bonding. Accordingly, the exemplary implementations set forth above, are intended to be illustrative, not limiting.

What is claimed is:

1. A wafer bonding chamber, comprising:
a plurality of fixtures, each supporting one wafer on a frontside of the fixture; and
at least one of a heating mechanism and a cooling mechanism, configured so as to maintain one of the wafers in one of the fixtures at a substantially different temperature than another wafer in another of the plurality of fixtures.

2. The wafer bonding chamber of claim 1, wherein the cooling mechanism comprises a stream of inert gas directed at a backside of at least one of the fixture and the wafer.

3. The wafer bonding chamber of claim 1, wherein the heating mechanism comprises a radiation source, wherein the radiation is directed against an exposed side of the wafer to heat the wafer.

4. The wafer bonding chamber of claim 1, further comprising a refrigerated coolant provided to at least one of the fixtures.

5. The wafer bonding chamber of claim 1, wherein the wafer bonding chamber further comprises a resistive heating structure disposed in one of the fixtures.

6. The wafer bonding chamber of claim 4, wherein the permeable magnetic material comprises an alloy of nickel and iron.

7. The wafer bonding chamber of claim 1, further comprising both a heating mechanism and a cooling mechanism, wherein the heating mechanism heats one of the wafers and the cooling mechanism comprises helium introduced into the wafer bonding chamber.

8. The wafer bonding chamber of claim 1, wherein the heating source comprises:
a coil of wire surrounding one of the fixtures, to which an RF signal is applied, and wherein the wafer supported in the fixture has a permeable magnetic material deposited thereon.

9. The wafer bonding chamber of claim 8, wherein the wafer further comprises at least one of a bonding material and a getter material disposed adjacent to the magnetically permeable material.

10. The wafer bonding chamber of claim 8, further comprising:
a power supply that provides an RF signal to the coil, wherein the RF signal has a frequency between about 1 kHz and 100 kHz, and a power level between about 1 watt and 500 watts.

11. The wafer bonding chamber of claim 8, wherein the wafer further comprises a cavity formed beneath the permeable magnetic material.

12. The wafer bonding chamber of claim 9, wherein the bonding material comprises one component of a metal alloy hermetic sealing material, and the another wafer comprises another component of the metal alloy hermetic sealing material.

13. The wafer bonding chamber of claim 12, wherein the one component comprises at least one of gold and indium, and the magnetically permeable material comprises at least one of a Ni/Fe alloy, a cobalt alloy and a manganese alloy, and has a permeability of between about 10 and 20 T.

14. The wafer bonding chamber of claim 1, wherein the heating source comprises:
a coil of wire embedded in one of the fixtures, to which an RF signal is applied, and wherein the wafer supported in the one of the fixtures has a permeable magnetic material deposited thereon.

15. The wafer bonding chamber of claim 14, wherein the wafer further comprises at least one of a getter material and a bonding material disposed adjacent to the magnetically permeable material.

16. The wafer bonding chamber of claim 14, wherein the getter material comprises an alloy containing at least one of vanadium, zirconium and iron, and readily absorbs contaminant gases and humidity.

17. The wafer bonding chamber of claim 14, further comprising:
a power supply that provides an RF signal to the coil, wherein the RF signal has a frequency between about 1 kHz and 100 kHz, and a power level between about 1 watt and 500 watts.

18. The wafer bonding chamber of claim 17, further comprising:
a magnetic core around which the coil is wound.

19. The wafer bonding chamber of claim 15, wherein the magnetically permeable material comprises at least one of a Ni/Fe alloy, a cobalt alloy and a manganese alloy, and has a permeability of between about 10 and 20 T.

20. The wafer bonding chamber of claim 15, wherein the getter material comprises at least one of vanadium, zirconium and iron, and readily absorbs contaminant gases and humidity.
